(19) United States
(12) Patent Application Publication
(10) Pub. No.: US 2008/0046749 A1
(43) Pub. Date: Feb. 21, 2008

(54) APPARATUS AND METHOD FOR DISABLING AN ORIGINAL PASSWORD OF AN ELECTRICAL APPARATUS

(75) Inventors: Jimmy Su, Taoyuan County (TW); Yu-Min Hsiao, Taoyuan County (TW); Wen-Chieh Kuo, Taoyuan County (TW)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: DELTA ELECTRONICS, INC., Taoyuan County (TW)

(21) Appl. No.: 11/624,537

(22) Filed: Jan. 18, 2007

(30) Foreign Application Priority Data
Aug. 18, 2006 (TW) 095130454

(51) Int. Cl. G06F 12/14; H04L 9/00; H04L 9/32; G06F 12/00; H04K 1/00; G06F 13/00; G06F 17/30; G06F 7/04; G06F 7/58; G06K 19/00; G11C 7/00

(52) U.S. Cl. 713/183; 726/18; 726/19

(57) ABSTRACT

Apparatus and method for disabling an original password of an electronic device are provided. The apparatus comprises a message generator, an interface, and a processing unit. The message generator is configured to generate a message code. The interface is configured to receive an input password and communicate with the electronic device. The processing unit is configured to determine whether the input password corresponds to the message code and if so, to disable the original password. The method comprises the steps executed by the apparatus.

This application claims priority to Taiwan Patent Application No. 095130454 filed on Aug. 18, 2006, the disclosures of which are incorporated herein by reference in its entirety.

### CROSS-REFERENCES TO RELATED APPLICATIONS

Not applicable.

### BACKGROUND OF THE INVENTION

1. Field of the Invention

The present invention relates to an apparatus and a method for disabling an original password; more particularly, the present invention relates to an apparatus and a method for disabling an original password using a message code generated by a message generator.

2. Descriptions of the Related Art

Many electronic devices on the market today such as projectors are set with power-on passwords to prevent the use of unauthorized users. In order to use a password-protected electronic device, a user has to input the correct power-on password. By using this interface, the management of electronic devices can be easily achieved. However, when a valid user forgets or loses the power-on password for an electronic device, the power-on password has to be disabled so that the valid user can use the device. Consequently, allowing a valid user to disable the power-on password when the user forgets or loses it is a problem that people in this field face.

Currently, methods to disable an original password can be classified into two categories. Methods of the first category use a mutual password for all electronic devices. Lenovo M500 projectors and Lenovo C500 projectors of IBM (International Business Machines Corporation) are examples of machines that use methods of this category. Since all of these projectors use the same mutual password, projectors are not protected once the mutual password is known by others.

Methods of the other category encode a serial number in an electronic device and use the encoding result to disable the original password. VP6320 projectors of Hewlett-Packard, IN24 and IN21 projectors of Infocus, and NP2000 projectors of NEC are examples of machines that utilize methods of this category. During the manufacturing process, these methods need to burn a serial number on the Electrically Erasable Programmable Read-Only Memory (EEPROM). Every electronic device has its own specific serial number. When a user forgets or loses the password, the user provides the serial number to the customer service center to get a disabling password. The user then uses the disabling password to disable the original password. The disadvantage of methods of this category is that an extra EEPROM is required in the electronic device in order to store the serial number. Furthermore, the burning process has to be set in the production line, which increases the overall cost of the electronic device.

According to the aforementioned description, providing an easy, inexpensive, and secure method to disable the original password so that a valid user can use the electronic device when he or she forgets or loses the original password is necessary.

### SUMMARY OF THE INVENTION

The primary objective of the present invention is to provide an apparatus for disabling an original password of an electronic device. The apparatus comprises a message generator, an interface, and a processing unit. The message generator is configured to generate a message code while the interface is configured to receive an input password and communicate with the electronic device. The processing unit is configured to determine whether the input password corresponds to the message code and disable the original password if the input password corresponds to the message code.

Another objective of the present invention is to provide a method for disabling an original password of an electronic device. The method comprises the steps of generating a message code, receiving an input password, determining whether the input password corresponds to the message code, and disabling the original password if the input password corresponds to the message code.

Based on the aforementioned arrangement, a message code can be generated by a message generator when a user loses an original password. The message code is then provided to a customer service center. The customer service center utilizes a decoding process to decode the message code into a special password, which can disable the original password. After the user enters the special password, the original password is disabled and the electronic device can be operated. If the user forgets or loses the original password again, another message code can be generated by the message generator again and another special password is derived from the customer service center again. Since the message code is randomly generated by the message generator, the probability that the message code is repeated is extremely small. Consequently, the user does not have to worry about the loss of the message code for the special password. Furthermore, no extra process is required at the production line of the factory, so the additional cost of the present invention is considerably less.

The detailed technology and preferred embodiments implemented for the subject invention are described in the following paragraphs accompanying the appended drawings for those skilled in this field to well appreciate the features of the claimed invention.

### BRIEF DESCRIPTION OF THE DRAWINGS

FIG. 1 illustrates the apparatus of the first embodiment of the present invention; and

FIG. 2 illustrates the flowchart of the second embodiment of the present invention.

### DESCRIPTION OF THE PREFERRED EMBODIMENT

The present invention provides apparatuses and methods for disabling an original password of an electronic device. The electronic device can be a projector, a multi-function printer, a copier machine, a computer, or the like.

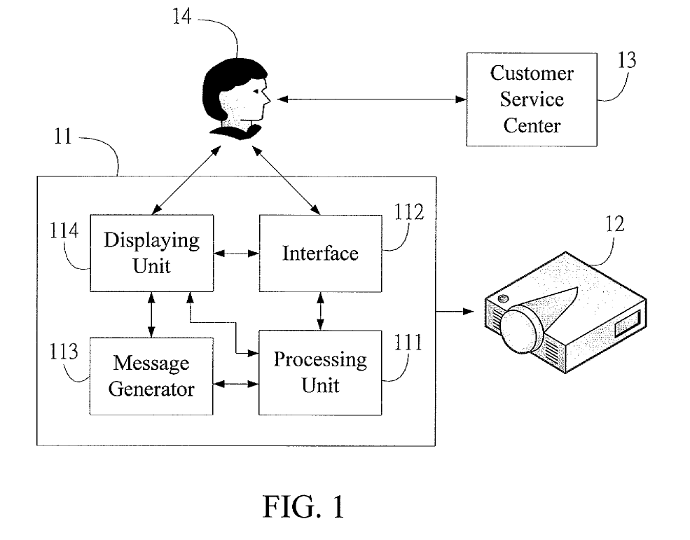

FIG. 1 illustrates a first embodiment of the present invention which is an apparatus 11 for disabling an original password of a projector 12. The apparatus 11 is wirelessly connected to the projector 12 in order to control it. For other modifications, the apparatus 11 can be directly electrically connected to the projector 12. The connection method between the two is not limited to the scope of the present invention. The apparatus 11 comprises a processing unit 111, an interface 112, a message generator 113, and a displaying unit 114. The processing unit 111 can be any current or future microprocessor or CPU, the interface 112 can be any current or future receiving mechanism, and the displaying unit 114 can be any current or future displaying apparatus such as LCD display. The communication between the apparatus 11 and the projector 12 is achieved through the interface 112.

First, the processing unit 111 determines whether the original password has been set. If the original password has not been set, the processing unit 111 makes the projector 12 operable. If the processing unit 111 determines that the original password is set, for example, <Up><Down><Left><Right> (the four operation keys to control the projector 12), the displaying unit 114 displays a message for entering the input password.

Then, the processing unit 111 determines if the waiting period is longer than 3 minutes, wherein the length of waiting period is the length of time after the message for entering the input password is displayed. If it is longer than 3 minutes, the processing unit 111 stops waiting and turns off the projector 12. If it is not longer than 3 minutes, the interface 112 keeps waiting to receive an input password from a user 14. Additionally, the user 14 has several chances to enter the input password. That is, if the input password entered by the user 14 is incorrect, the interface 112 may ask the user 14 to reenter the input password for a certain number of times. The details on the design that the user 14 has several chances to enter the input password are described later. The aforementioned waiting period as 3 minutes is used as an example but is not used to limit the scope of the present invention. Any length of time will not affect the operation of the present invention.

After the interface 112 receives the input password, the processing unit 111 determines whether the input password, using the previous example, is <Up><Down><Left><Right> or a special password. For the time being, the special password will be explained later. If the input password is <Up><Down><Left><Right> or the special password, the processing unit 111 further determines whether the input password corresponds to a message code. The content of the message code will be explained later. If the input password entered by the user 14 is <Up><Down><Left><Right>, i.e. the original password, it also means that the input password does not correspond to the message code. Thus, the processing unit 111 makes the projector 12 operable without extra actions. This case relates to the situation that the user 14 remembers and has the original password.

If the input password entered by the user 14 is invalid, i.e. the processing unit 111 determines that the input password is neither <Up><Down><Left><Right> nor the special password, the processing unit 111 proceeds with a series of determinations to perform different actions. First, the processing unit 11 determines whether the number of times of error is smaller than 10 times, wherein the number of times of error is the accumulated number of times that the input password is not the original password and is not the special password. If the answer is no, the processing unit 111 turns off the projector 12 meaning that the number of times of error is too large. If the number of times of error is smaller than 10 times, the processing unit 111 further determines whether it is greater than 5 times. If the number of times of error is not greater than 5 times, the displaying unit 114 displays a message of reentering the input password so that the user 14 can enter the input password again. If the number of times of error is greater than 5 times, then the message generator 113 generates the message code, e.g. 60800000 for proceeding the disabling of the original password. It is noted that the message code generated by the message generator 113 can be a random number (like 60800000 in this embodiment), a pattern, or a mixture of numbers and characters, such as “0&1”. In addition, it is necessary to mention that the aforementioned 5 times and 10 times are used as examples but are not used to limit the scope of the present invention. They can be set to other numbers depending on the practical requirements.

The message code 60800000 and the aforementioned special password are explained here. After the message generator 113 generates the message code 60800000, the displaying unit 114 displays the message code 60800000 to the user 14. The user 14 then informs the customer service center 13 of the message code 60800000 so that the customer service center 13 can utilize a decoding program to decode the message code 60800000 into a special password, e.g. <Up><Up><Down><Left><Right><Down>. The processing unit 111 executes the same decoding program to get the special password <Up><Up><Down><Left><Right><Down>. Thus, the processing unit 111 considers that the message code 60800000 corresponds to the special password <Up><Up><Down><Left><Right><Down>. How the message code 60800000 corresponds to the special password <Up><Up><Down><Left><Right><Down> is determined by the decoding program. The decoding program is not used to limit the scope of the present invention. Any program that has the encoding and decoding abilities can be utilized in the present invention.

Then, the explanation returns to the apparatus 11. After the displaying unit 114 displays the message code 60800000, it displays a message for the reentering of an input password. The interface 112 receives the input password entered by the user 14 again. It needs to mention that the user 14 has several chances to enter the correct input password. That is, if the input password entered by the user 14 is incorrect, the interface 112 may ask the user 14 to reenter the input password. The user 14 can enter the special password <Up><Up><Down><Lef><Right><Down> obtained from the customer service center. The processing unit 111 then determines whether the input password is the original password or the special password. That is, the processing unit 111 determines whether the input password is <Up><Down><Left><Right> or <Up><Up><Down><Left><Right><Down>. Since the input password entered by the user 14 in this case is <Up><Up><Down><Left><Right><Down>, the processing unit 111 determines the input password is the special password. Next, the processing unit 111 determines whether the input password corresponds to the message code 60800000. Since the processing unit 111 has decoded the message code 60800000 as <Up><Up><Down><Left><Right><Down> by the decoding program, the processing unit 111 determines that the input password corresponds to the message code. Then, the processing unit 111 disables the original password <Up><Down><Left><Right> and makes the projector 12 operable. Since the original password is disabled, anybody can use the projector 12, which is now not protected. If the user 14 considers that the projector 12 has to be protected again, a new original password can be set again.

The message code is generated by the message generator 113 which comprises random information, so message codes are different from time to time. If the user 14 loses the original password again, another message code will be derived, which corresponds to another special password. Consequently, the apparatus 11 of the present invention for disabling the original password provides robust protection. Users do not have to worry the consequences of losing the message code for the special password.

It is necessary to emphasize that the length of waiting period, the number of times of error, etc, can be adjusted according to the practical situation. Furthermore, the original password and the special password are not limited to the combination of keys of <Up>, <Down>, <Left>, and <Right>. Any key that appear on the apparatus 11 can be utilized. The lengths of the original password and the special password can be modified and the two lengths do not have to be the same. Moreover, the decoding program is not limited to any specific program. Any program that has a decoding ability can be adopted in the present invention.

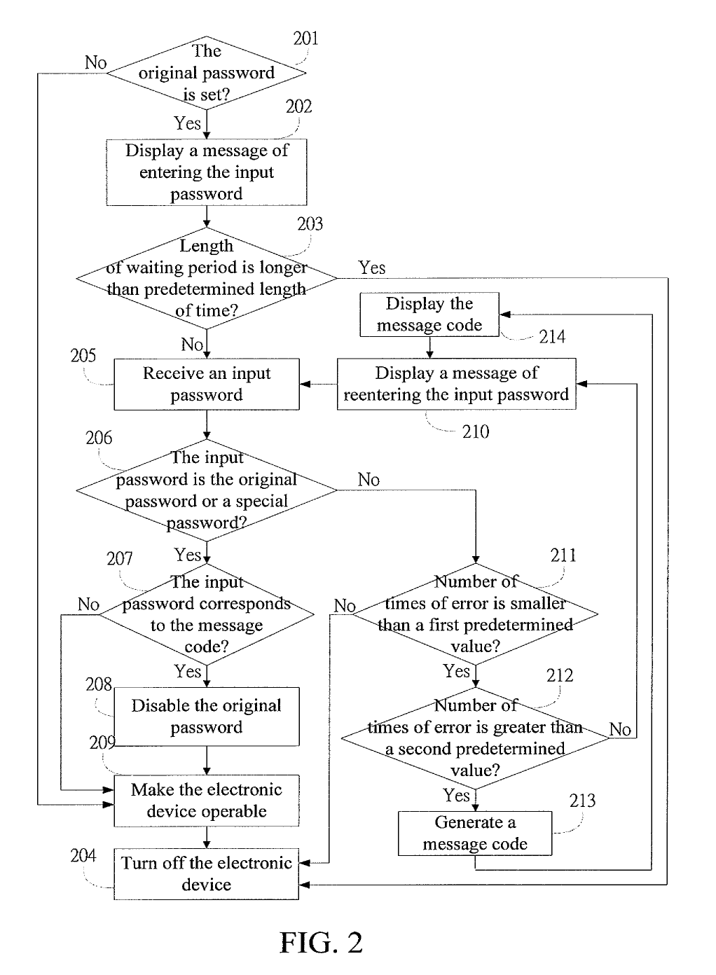

FIG. 2 illustrates the second embodiment of the present invention, which is a flowchart of a method for disabling an original password of an electronic device. First, the method executes step 201 to determine whether the original password is set. If the original password is not set, step 209 is executed to make the electronic device operable. If the original password is set, step 202 is executed to display a message for the entering of the input password. Then, step 203 is executed to determine whether the length of the waiting period is longer than a predetermined length of time. If it is yes, then step 204 is executed to turn off the electronic device. If the length of waiting period is not longer than the predetermined length of time, step 205 is executed to receive an input password.

Different steps are executed according to the input password. First, step 206 is executed to determine whether the input password is the original password or a special password, that is, whether the input password is valid. If the input password is valid, step 207 is executed to determine whether the input password corresponds to a message code. If the input password is the original password, that is, the input password does not correspond to the message code, step 209 is executed to make the electronic device operable. This case relates to the situation when the user remembers the original password.

If it is no in step 206, that is, the user lost the original password so that the input password is neither the original password nor the special password, then step 211 is executed to determine whether a number of times of error is smaller than a first predetermined value. If not, step 204 is executed to turn off the electronic device. If the number of times of error is smaller than the first predetermined value, step 212 is then executed to determine whether the number of times of error is greater than a second predetermined value. If not, step 210 is executed to display a message for the reentering of the input password and then step 206 is executed again.

If the number of times of error is greater than the second predetermined value, step 213 is executed to generate the message code. Then, step 214 is executed to display the message code to the user. The user provides the message code to the customer service center, which then generates a special password by a decoding program based on the message code.

After the step 214, step 210 is executed to display a message for the reentering of the input password. Then, step 205 is executed to receive the input password. In this case, the user has obtained the special password, so the special password is entered. Then, step 206 is executed again to determine whether the input password is the original password or the special password. Since the input password in this case is the special password, step 207 is then executed to determine whether the input password corresponds to the message code. The answer of the step 207 is yes because the special password is generated based on the message code. Step 208 is then executed to disable the original password and then step 209 is executed to make the electronic device operable. Due to the fact that the original password is disabled, anybody can use the electronic device, which is now not protected. If the user decides that the projector has to be protected again, a new original password can be set again. In addition to the steps illustrated in FIG. 2, the second embodiment is able to perform all the functions and operations executed in the first embodiment.

It is necessary to emphasize that the length of waiting period, the first predetermined value, and the second predetermined value can be adjusted according to the practical situation. Furthermore, the original password and the special password do not have to utilize the same keys and do not have to be the same length. Moreover, the decoding program is not limited to any specific program. Any program that has a decoding ability can be adopted in the present invention.

According to the aforementioned description, when a user forgets or loses an original password, a message code is generated by a message generator. The user then provides the message code to a customer service center. The customer service center decodes the message code by a decoding program and gets a special password to disable the original password. After the special password is entered, the original password is disabled and the user can use the electronic device. If the user loses the original password again, the message generator is used again to generate another message code and a special password is again derived from the customer service center. Since the message code is generated by the message generator, the probability that the message code repeats is very small. Consequently, the user does not have to worry about the losing of the message code and the special password. In addition, extra flows or steps are not required in the factory, so the cost increase of the present invention is minimal.

The above disclosure is related to the detailed technical contents and inventive features thereof. Those skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for disabling an original password of an electronic device, the apparatus comprising:
a message generator for generating a message code;
an interface for receiving an input password and communicating with the electronic device; and
a processing unit for determining whether the input password corresponds to the message code and for disabling the original password if the input password corresponds to the message code.

2. The apparatus of claim 1, further comprising:
a displaying unit for displaying the message code and for displaying a message of reentering the input password, wherein the interface receives the input password in response to the displaying of the message.

3. The apparatus of claim 1, wherein the processing unit further determines whether the input password is the original password or a special password, the special password is generated based on the message code by a decoding program in a customer service center, the processing unit comprises the decoding program, and the processing unit determines whether the input password corresponds to the message code if the input password is the original password or the special password.

4. The apparatus of claim 3, wherein the processing unit further determines whether a number of times of error is smaller than a first predetermined value if the input password is neither the original password nor the special password, the number of times of error is the accumulated number of times that the input password is neither the original password nor the special password, the processing unit further determines whether the number of times of error is greater than a second predetermined value if the number of times of error is smaller than the first predetermined value, wherein the message generator generates the message code if the number of times of error is greater than the second predetermined value.

5. The apparatus of claim 4, wherein the processing unit further turns off the electronic device if the number of times of error is not smaller than the first predetermined value.

6. The apparatus of claim 4, further comprising:
a displaying unit for displaying a message of reentering the input password if the number of times of error is not greater than the second predetermined value.

7. The apparatus of claim 1, wherein the processing unit further determines whether the original password is set and the interface receives the input password if the original password is set.

8. The apparatus of claim 7, further comprising:
a displaying unit for displaying a message of entering the input password.

9. The apparatus of claim 8, wherein the processing unit further determines whether a length of waiting period is longer than a predetermined length of time, the length of waiting period is a length of lapse of time to receive the input password after the displaying of the message of entering the input password, and the processing unit turns off the electronic device if the length of waiting period is longer than the predetermined length of time.

10. The apparatus of claim 9, wherein the interface receives the input password if the length of waiting period is not longer than the predetermined length of time.

11. The apparatus of claim 1, wherein the electronic device is a projector.

12. A method for disabling an original password of an electronic device, the method comprising the steps of:
generating a message code;
receiving an input password;
determining whether the input password corresponds to the message code; and
disabling the original password if the input password corresponds to the message code.

13. The method of claim 12, further comprising the step of:
displaying the message code; and
displaying a message of reentering the input password;
wherein the receiving steps receives the input password in response to the step of displaying a message of reentering the input password.

14. The method of claim 12, wherein the message code is generated by a message generator of the electronic device.

15. The method of claim 12, further comprising the steps of:
determining whether the input password is the original password or a special password, the special password being generated based on the message code by a decoding program in a customer service center;
wherein the step of determining whether the input password corresponds to the message code is executed if the input password is the original password or the special password.

16. The method of claim 15, further comprising the steps of:
determining whether a number of times of error is smaller than a first predetermined value if the input password is neither the original password nor the special password, the number of times of error being the accumulated number of times that the input password being neither the original password nor the special password; and
determining whether the number of times of error is greater than a second predetermined value if the number of times of error is smaller than the first predetermined value;
wherein the generating step generates the message code if the number of times of error is greater than the second predetermined value.

17. The method of claim 16, further comprising the step of turning off the electronic device if the number of times of error is not smaller than the first predetermined value.

18. The method of claim 16, further comprising the step of displaying a message of reentering the input password if the number of times of error is not greater than the second predetermined value.

19. The method of claim 12, further comprising the step of determining whether the original password is set, wherein the receiving steps receives the input password if the original password is set.

20. The method of claim 19, further comprising the step of generating a message of entering the input password.

21. The method of claim 20, further comprising the steps of:
determining whether a length of waiting period is longer than a predetermined length of time, the length of waiting period being a length of lapse of time to receive the input password after the displaying of the message of entering the input password; and
turning off the electronic device if the length of waiting period is longer than the predetermined length of time.

22. The method of claim 21, wherein the receiving step is executed if the length of waiting period is not longer than the predetermined length of time.
